(19) United States
(12) Patent Application Publication
(10) Pub. No.: US 2015/0304439 A1
(43) Pub. Date: Oct. 22, 2015

(54) COMMUNICATION DEVICE AND COMMUNICATION METHOD

(71) Applicants: Takuji Morimoto, (US); Yoshihiko Mori, (US); Shinji Akatsu, (US)

(72) Inventors: Takuji Morimoto, Tokyo (JP); Yoshihiko Mori, Tokyo (JP); Shinji Akatsu, Tokyo (JP)

(73) Assignee: Mitsubishi Electric Corporation, Tokyo (JP)

(21) Appl. No.: 14/441,033

(22) PCT Filed: Jan. 28, 2013
(86) PCT No.: PCT/JP2013/051759

§ 371 Date: May 6, 2015

(51) Int. Cl. H04L 29/08

(52) U.S. Cl. CPC H04L 67/22; H04L 67/12; H04L 67/1097

(57) ABSTRACT

A communication device includes: a purpose information estimator that estimates purpose information indicating a purpose of movement of a user who moves using the mobile object, based on mobile-object-specific information that includes at least one of a usage schedule and a usage history of the mobile object, and user-specific information that includes at least one of an activity schedule and an activity history of the user who moves using the mobile object; a formation-condition determinator that determines a formation condition for a virtual network for the mobile objects of which the purpose information estimated by the estimator is the same or similar, based on the mobile-object-specific information and the user-specific information in the plurality of mobile objects; and a virtual network former that forms a virtual network through which the mobile objects that satisfy the formation condition determined by the determinator among the plurality of mobile objects can communicate with each other.

### TECHNICAL FIELD

The present invention relates to a communication device and a communication method capable of performing communications between mobile objects such as a plurality of vehicles.

### BACKGROUND ART

There are many users who perceive as “being boring” a long trip in a mobile object such as a vehicle, and a variety of entertainments for eliminating the boredom have been suggested. In recent years, with popularization of social networking service (SNS), an attempt to provide “connections with other people” as an in-vehicle entertainment has been made, and a variety of SNS-enabled in-vehicle devices have appeared.

In a long trip by automobiles, vehicles having the same purpose may gather within a certain distance. For example, a case such that many vehicles moving from Nagoya to Gifu in an early morning in winter are heading for ski resorts is specified. In these cases, if there exists a system that cars (drivers) having the same purpose can perform communication with each other, it is conceived that the boredom can be eliminated, and also that new friends can be created.

### CITATION LIST

### Patent Document

Patent Document 1: Japanese Patent Application Laid-Open No. 2004-78562

Patent Document 2: Japanese Patent Application Laid-Open No. 2004-118610

### SUMMARY OF THE INVENTION

### Problems to be Solved by the Invention

However, under the current SNS technology, it may be difficult to find and connect vehicles having the same purposes from both functionality and safety side in operation during traveling. Moreover, conventional inter-vehicle communication devices disclosed in Patent Documents 1 and 2, for example, propose a communication method of forming a virtual network with surrounding vehicles to exchange information; however, it is limited to sharing of information with the surrounding, and an effect of making new friends cannot be expected.

The present invention has been made to solve the drawbacks described above, and an object of the invention is to provide a communication device and a communication method capable of, during traveling of a mobile object, automatically connecting with a user of another mobile object to perform communication.

### Means for Solving the Problems

In order to attain the object, according to the present invention, a communication device that has a function of communicating with a plurality of mobile objects includes: a purpose information estimator that estimates purpose information indicating a purpose of movement of a user who moves using the mobile object, based on mobile-object-specific information that includes at least one of a usage schedule and a usage history of the mobile object, and user-specific information that includes at least one of an activity schedule and an activity history of the user who moves using the mobile object; a formation-condition determinator that determines a formation condition for a virtual network for mobile objects of which the purpose information estimated by the purpose information estimator is the same or similar, based on the mobile-object-specific information and the user-specific information in the plurality of mobile objects; and a virtual network former that forms a virtual network through which mobile objects that satisfy the formation condition determined by the formation-condition determinator among the plurality of mobile objects can communicate with each other.

### Effect of the Invention

According to the invention, during traveling of the mobile object, a user of another mobile object matched in purpose and/or hobby is automatically connected therewith to perform communication, and it is thus possible to eliminate the boredom in a long trip and to make new friends.

### BRIEF DESCRIPTION OF THE DRAWINGS

FIG. 1 is a block diagram illustrating a configuration of a communication system of Embodiment 1.

FIG. 2 is a flowchart illustrating a procedure in which a purpose information estimating unit estimates and sets purpose information.

FIG. 3 is a display example illustrating, on a display device of a mobile object, that another mobile object in its own virtual network is a fellow member.

FIG. 4 is a block diagram illustrating a configuration of a communication system in Embodiment 2.

FIG. 5 is a block diagram illustrating a configuration of a communication system in Embodiment 3.

FIG. 6 is a block diagram illustrating a configuration of a communication system in Embodiment 4.

FIGS. 7(a) and 7(b) are diagrams each illustrating a positional relation between mobile objects in a virtual network of a communication system in Embodiment 5.

FIG. 8 is a block diagram illustrating a configuration of a communication system in Embodiment 6.

FIG. 9 is a block diagram illustrating another configuration of the communication system in Embodiment 6.

### MODES FOR CARRYING OUT THE INVENTION

Hereinafter, embodiments of the present invention will be described in detail with reference to the drawings.

### Embodiment 1

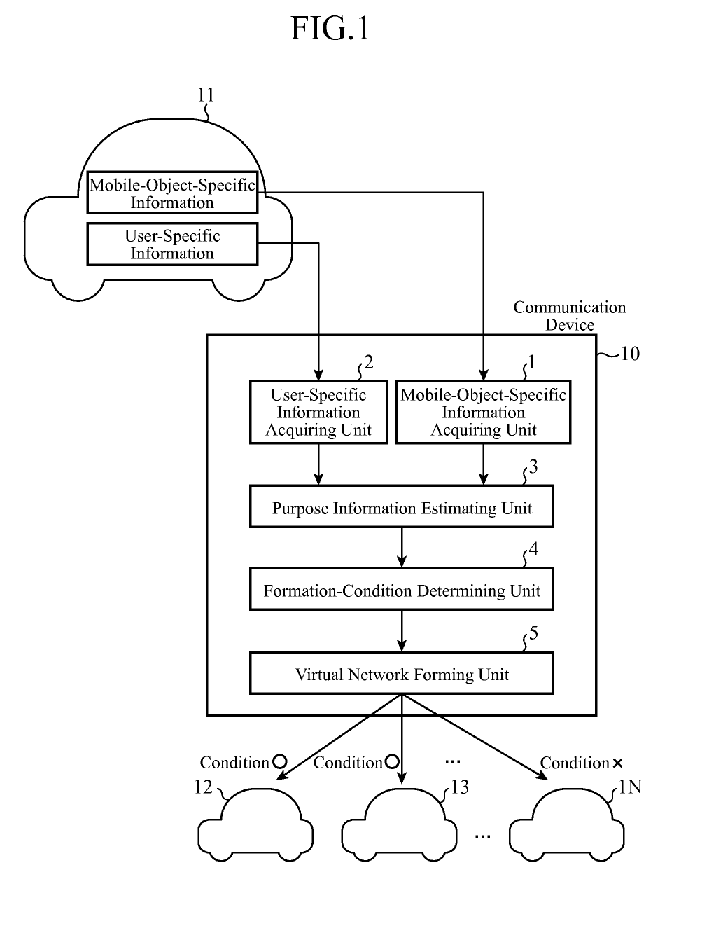

FIG. 1 is a block diagram illustrating a configuration of a communication system in Embodiment 1 of the present invention. As illustrated in FIG. 1, this communication system is configured by a communication device 10 and a plurality of mobile objects 11 to 1N. Then, the communication device 10 includes a mobile-object-specific information acquiring unit 1, a user-specific information acquiring unit 2, a purpose information estimating unit 3, a formation-condition determining unit 4, and a virtual network forming unit 5, and has a function of communicating with the plurality of mobile objects 11 to 1N. It is noted that description and illustration for a communication unit for communicating with the plurality of mobile objects 11 to 1N will be omitted.

In addition, in Embodiment 1, description is made on the assumption that a server on a network has the function of the communication device 10.

Incidentally, although an automobile is described here as an example of a mobile object, it is not limited to a communication device for the automobile, but it is also applicable to entities in any forms, for example, for the mobile objects including vehicles other than motorcycles, and/or automobiles such as buses etc., persons, trains, ships, and so on. The same applies to Embodiments 2 to 6 below.

The mobile-object-specific information acquiring unit 1 acquires mobile-object-specific information kept by a mobile object and/or an in-vehicle information device mounted on the mobile object. Here, the mobile-object-specific information includes at least one of a usage schedule and a usage history of the mobile object. When the mobile object is the automobile, the pieces of information as indicated in the following (1) to (3), for example, are specified for the mobile-object-specific information: (1) information on destinations or routes such as a destination, a stopover, a genre of the destination and/or stopover, a guided route, a past traveling route, etc.; (2) information on spot searches such as a spot search history, the genre searched in the past, a spot registered as a favorite, etc.; and (3) vehicle information such as a vehicle speed, the latitude and longitude of a present place, etc.

The user-specific information acquiring unit 2 acquires user-specific information, such as a hobby, a preference, a schedule, etc. of a user who uses the mobile object, from mobile information terminals possessed by the user in the mobile object, for example, a smartphone, a tablet, a note PC, etc. Here, the user-specific information includes at least one of an activity schedule and an activity history of the user who moves using the mobile object, and pieces of information as indicated in the following (1) and (2), for example, are specified: (1) information indicating hobbies and/or preferences such as applications installed in the mobile information terminal, applications frequently used by the user, Web bookmarks, Web access histories, etc.; and (2) schedule information such as calendar information in the mobile information terminal, tag information, an appointment schedule and/or a trip plan described in sent and received emails, etc.

The purpose information estimating unit 3 estimates and sets purpose information indicating a purpose of movement of the user who moves using the mobile object based on the mobile-object-specific information acquired by the mobile-object-specific information acquiring unit 1 and the user-specific information acquired by the user-specific information acquiring unit 2.

Here, the purpose information is complex information consisting of the following items: a destination name; a destination location (a latitude, a longitude, and an area of a prefecture, and/or a city, etc.); the genre (corresponding to a facility genre in car navigation, such as restaurants, stations, or ski resorts); and a purpose (such as eating, skiing, or sleeping). Incidentally, with respect to all items such as these destination name, destination location, and purpose, the information may be set, but blank items thereof may exist.

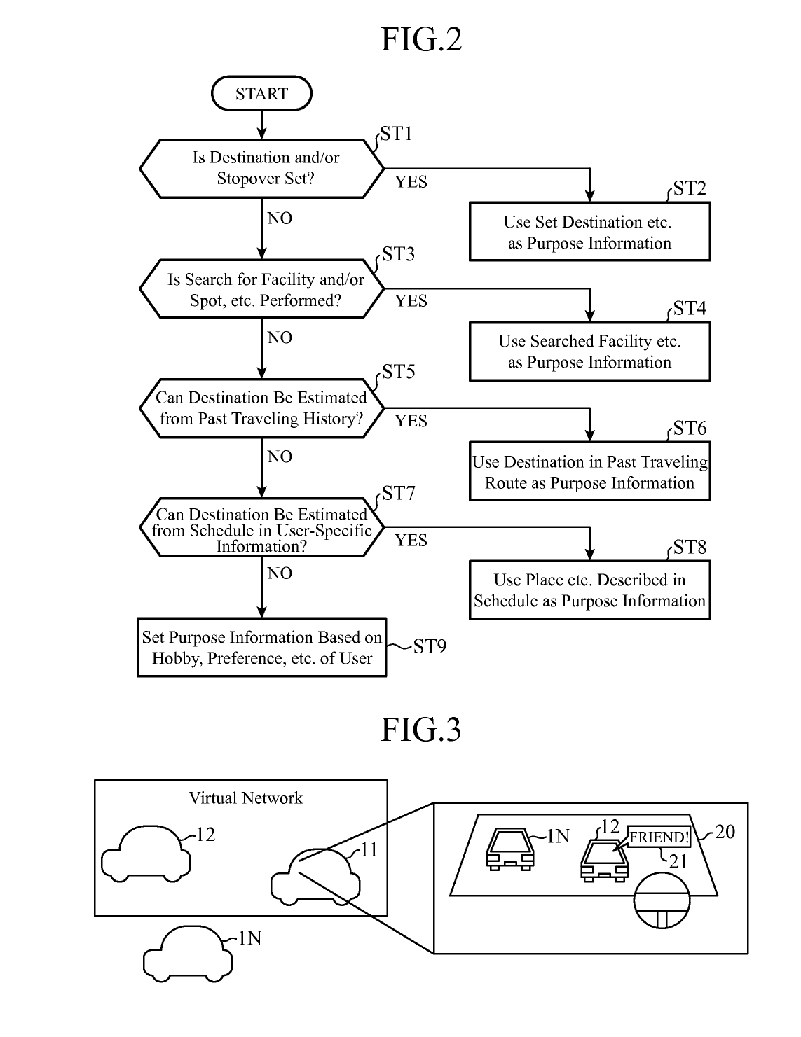

Then, a method of estimating the purpose information may be performed according to a flowchart illustrated in FIG. 2, for example. FIG. 2 is a flowchart illustrating a procedure in which the purpose information estimating unit 3 estimates and sets the purpose information.

First, when a destination and/or a stopover is set in the mobile-object-specific information, that is, when the mobile-object-specific information acquiring unit 1 can acquire the mobile-object-specific information of the destination, and/or stopover, etc. (step ST1: YES), the information of the set destination and/or stopover (the name, the latitude and longitude of a facility and/or a spot, the facility genre, etc.) is used as the purpose information (step ST2). On the other hand, in a case where the destination and/or stopover is not set (step ST1: NO), when a search for the facility and/or spot, etc. is performed (step ST3: YES), the searched facility etc. are used as the purpose information (step ST4).

When the destination etc. is not set and the search for the facility etc. is not performed (step ST3: NO), it is determined whether or not the destination can be estimated from a past traveling history of the user (step ST5). A known technique may be used for a method of estimating the destination based on the traveling history; for example, the following method is specified: comparing a past traveling route with a present traveling route at the same season and at the same time zone; and using the destination of the past traveling route as the destination of the present traveling route if a degree of similarity between both traveling routes is a predetermined value or higher. When the destination can be estimated in this manner (step ST5: YES), the destination of the past traveling route is used as the purpose information (step ST6).

On the other hand, in a case where the destination cannot be estimated: for example, when no route similar to the present traveling route exists in the past traveling routes (step ST5: NO), it is determined whether or not the destination can be estimated from the schedule in the user-specific information acquired by the user-specific information acquiring unit 2 (step ST7). For example, when “skiing in Gifu on DAY XX” is described in a calendar application of a smartphone as the user-specific information, “Gifu,” “Ski Resort,” and “Skiing” are estimated as the location information, genre, and purpose, respectively. When the purpose information can be estimated in this manner (step ST7: YES), it is used as the purpose information (step ST8).

On the other hand, when no information indicating the destination and/or purpose exists in the schedule of the user, so that the purpose information cannot be estimated (step ST7: NO), the purpose information (genre item and/or purpose item etc.) is set based on the hobby and preference of the user, and/or the genre of the places where the user visited frequently in the past, etc. (step ST9).

It is noted that the estimation procedure described above is one example; for example, the operation is performed without problems even if the steps ST5 and ST6 are replaced in order with the steps ST7 and ST8. Moreover, when the purpose information cannot be estimated by the processing up to the step ST6, for example, it may be configured that formation of a virtual network is stopped due to an impossible estimation for the purpose information.

The formation-condition determining unit 4 determines a formation condition for forming the virtual network of the mobile objects of which the purpose information estimated by the purpose information estimating unit 3 is the same or similar, based on the mobile-object-specific information and the user-specific information in the plurality of mobile objects. This formation condition includes a plurality of comparison items. A comparison target item is an item included in any one of the mobile-object-specific information, the user-specific information, and the purpose information estimated by the purpose information estimating unit 3 from these two pieces of information, and is the contents as illustrated in (1) and (2) below, for example: (1) Destination=Sanda Ski Resort; and (2) Destination Location=Hyogo Prefecture, and Genre=Ski Resort.

Which item will be set as the formation condition changes depending on ambiguity of the purpose information (probability of estimation). For example, when “Sanda Ski Resort” is set definitely as the purpose information by the purpose information estimating unit 3 described previously, the formation condition is set such that only the mobile objects of which the destination in the mobile-object-specific information is “Sanda Ski Resort” are included in the virtual network. Moreover, in a case where ambiguous purpose information as in “Go to Ski Resort in Hyogo area” is estimated, the formation condition is set such that all mobile objects having the same destination location and genre are included in the virtual network.

Additionally, the formation condition may be increased or decreased depending on the mobile-object-specific information or the user-specific information. For example, in a case where due to the user-specific information such as an SNS history etc., it turns out that the user has a personality that wants connections with others, even if the purpose information definitely indicates “Go to Sanda Ski Resort,” the formation condition may be set such that all mobile objects of which the genre of the purpose is estimated to be “Ski Resort” are incorporated in the virtual network.

The virtual network forming unit 5 forms the virtual network through which the mobile objects that satisfy the formation condition determined by the formation-condition determining unit 4 among the plurality of mobile objects can communicate with each other.

Here, when a plurality of pieces of purpose information can be estimated in the purpose information estimating unit 3, the formation-condition determining unit 4 may determine and present a plurality of formation conditions based on these plurality of pieces of purpose information so as to urge a selection and/or input by the user. In this case, the virtual network forming unit 5 forms the virtual network using a group of mobile objects made up of the plurality of mobile objects that satisfies the formation condition selected by the user from among the plurality of formation conditions presented. Moreover, it may be configured such that the plurality of virtual networks are formed without urging the selection and/or input by the user.

As a result, for example, the communication device 10 illustrated in FIG. 1 estimates the purpose information based on the mobile-object-specific information and the user-specific information of the mobile object 11 to determine the formation condition. In a case where the mobile objects 12 and 13 satisfy the formation condition, the virtual network is formed by the mobile objects 11, 12, and 13, and the other mobile objects 14 to 1N are not included in the virtual network.

Then, the communication device 10 enables the mobile objects 11, 12, and 13 in the virtual network formed in this manner to perform communication mutually.

Here, in a case where the mobile object 13 does not satisfy the formation condition any longer due to, for example, a reason why the mobile object 13 changes the destination, the virtual network forming unit 5 excludes the mobile object (in this case, the mobile object 13) that no longer satisfies the above formation condition from the virtual network.

When a display device such as a car navigation system or a head-mounted display is provided in the mobile object (in this case, the mobile object 11), the location of the mobile object in the virtual network may be displayed on the display device to present the user which mobile object is connected to its own mobile object, to thereby provide a sense of togetherness and/or comfort.

FIG. 3 is a display example illustrating, on a display device 20 of the mobile object 11, that the mobile object 12 in its own virtual network is a friend.

In FIG. 3, a case that the mobile objects 12 and 1N exist ahead of the mobile object 11 is assumed, and a state in which the two mobile objects 12 and 1N traveling ahead are displayed on the display device 20 such as a head-mounted display in the mobile object 11 is illustrated. Then, since the mobile object 12 exists in the same virtual network, an indication 21 is presented, showing a fellow member named “FRIEND!” indicating that existence. Further, the corresponding indication 21 is not attached to the mobile object 1N not existing in the same virtual network.

As described above, according to Embodiment 1, a driver taking a long trip by the automobile, for example, can automatically connect with other drivers having the same destination via the virtual network in the middle of the trip; by performing communication by a chat and/or a telephone call, etc., tedium to arrival at the destination can be eliminated. Even in a case such that the destination is not set on the car navigation system because of going to a familiar place, the purpose information is estimated from the mobile-object-specific information and the user-specific information, to thereby form the virtual network.

Moreover, according to Embodiment 1, an effect that changes a drive to a new meeting place can also be expected. For example, in a case where the formation-condition determining unit 4 sets a formation condition that adds sex and/or the number of persons to the condition, it becomes possible to create a meeting place between males and females, such that the virtual network is formed by three automobiles in total including an automobile having four males riding thereon, and two automobiles each having two females riding thereon.

Additionally, in Embodiment 1, it has been described on the assumption that the mobile-object-specific information acquiring unit 1 acquires the information possessed by the mobile object and/or the specific information possessed by the in-vehicle information device mounted on the mobile object; however, the same effect can be obtained even when the mobile information terminal keeps the mobile-object-specific information as well as the user-specific information. In this case, the effect of the invention can be obtained even when the mobile object 11 does not have the in-vehicle information device. Moreover, even in a case where during formation of a virtual network, the user in the corresponding virtual network transfers from the automobile to another mobile object such as a bicycle, as long as the user carries the mobile information terminal, the virtual network can be continuously formed in a similar fashion.

### Embodiment 2

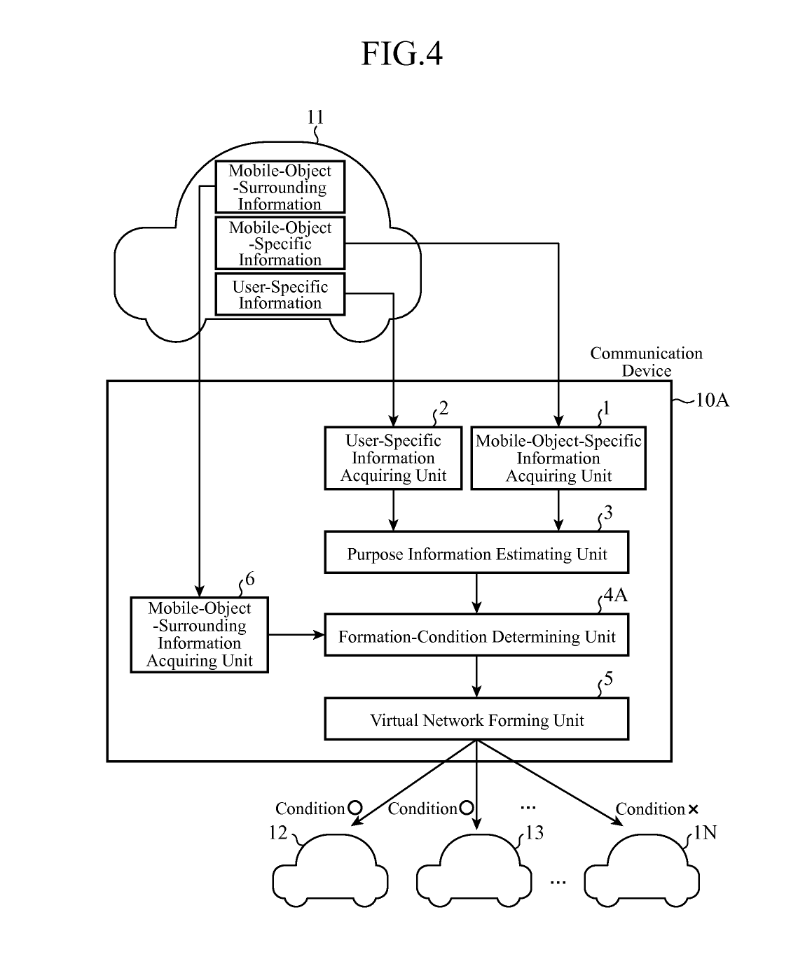

FIG. 4 is a block diagram illustrating a configuration of a communication system in Embodiment 2 of the present invention. The same constituent components as those described in Embodiment 1 will be denoted by the same reference numerals, and redundant descriptions thereof will be omitted. In Embodiment 2 described below, as compared with Embodiment 1, a communication device 10A includes a mobile-object-surrounding information acquiring unit 6, and a formation-condition determining unit 4A changes ease of formation of a virtual network based on the purpose information estimated by a purpose information estimating unit 3 and the mobile-object-surrounding information acquired by the mobile-object-surrounding information acquiring unit 6.

The mobile-object-surrounding information acquiring unit 6 acquires mobile-object-surrounding information such as road information, traffic information, and weather information of the surroundings of a mobile object from sensors provided in the mobile object, or through the Internet and/or a VICS (Vehicle Information and Communication System/registered trademark).

The formation-condition determining unit 4A determines a formation condition of a virtual network of mobile objects of which the purpose information is the same or similar, based on the surrounding information of a plurality of mobile objects in addition to the mobile-object-specific information and the user-specific information. Specifically, the determining unit finds users of which the purpose information estimated by the purpose information estimating unit 3 is similar, and changes the looseness of the formation condition for the virtual network (ease of formation) according to the mobile-object-surrounding information acquired by the mobile-object-surrounding information acquiring unit 6 when determining the formation condition for forming the virtual network.

In a situation in which the mobile object has no choice but to decrease the speed, for example, in a traffic jam etc., since it is expected that the user feels bored, the formation condition is set loose, which causes the virtual network to be formed easily. In addition, in a situation in which the mobile object has no choice but to move carefully due to, for example, accidents, rain, dense fog, etc. in order to prevent the mobile object from causing or encountering an accident due to getting distracted by communication, the formation condition is set strict, which causes the virtual network to be formed hardly, and thus, the driver of the mobile object can easily concentrate on driving.

As a specific method of setting the formation condition loose, any one of the following methods (1) and (2) may be performed: (1) change the comparison items of the formation condition to more loose items; and (2) broaden the widths of the comparison items in the formation condition. For example, when a formation condition “Destination=Sanda Ski Resort” is loosened according to the above method (1), the formation condition comes to “Destination Location=Sanda, and Genre=Ski Resort”. Moreover, when a formation condition “Destination Location=Hyogo Prefecture” is loosened according to the above method (2), the formation condition comes to “Destination Location=Kansai District”.

As described above, according to Embodiment 2, in the boring situation, for example, in the traffic jam etc., it is possible to form the virtual network with high probability and to eliminate the boredom by the communication. In contrast, in a case such that the communication with other people disturbs driving, by decreasing the probability of the formation of the virtual network, drivers can drive safely.

### Embodiment 3

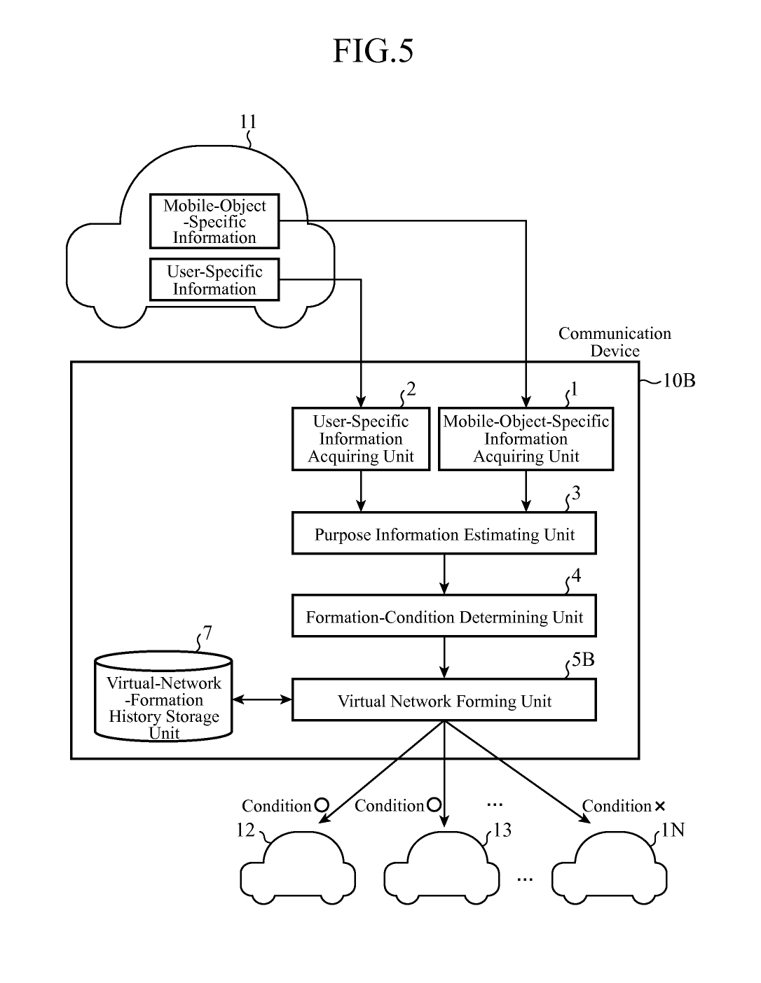

FIG. 5 is a block diagram illustrating a configuration of a communication system of Embodiment 3 of the present invention. The same constituent components as those described in Embodiments 1 and 2 will be denoted by the same reference numerals, and redundant descriptions thereof will be omitted. In Embodiment 3 described below, as compared with Embodiment 1, a communication device 10B includes a virtual-network-formation history storage unit 7, and a virtual network forming unit 5B forms a virtual network using formation history information stored in the virtual-network-formation history storage unit 7 in addition to a formation condition determined by a formation-condition determining unit 4.

The virtual-network-formation history storage unit 7 is a storage unit that stores a formation history of the virtual network formed by the virtual network forming unit 5B. In this manner, formation history information of the virtual network formed in the past is stored.

The virtual network forming unit 5B searches a mobile object that satisfies the formation condition determined by the formation-condition determining unit 4, and forms a virtual network based on the formation history information of the virtual networks formed in the past and stored in the virtual-network-formation history storage unit 7, and a predetermined condition, when forming the virtual network using a group of mobile objects satisfying the formation condition.

Here, the formation history information stored in the virtual-network-formation history storage unit 7 is used for the purpose of allowing the mobile objects connected by the same virtual network in the past to be easily connected again or conversely to be hardly connected again.

Moreover, in addition to a user-specified one designated in response to a selection request to a user, the predetermined condition used by the virtual network forming unit 5B may be the one to be determined from the user-specific information acquired by a user-specific information acquiring unit 2 by determining whether the user tends to want a close connection or a loose connection with other persons.

As described above, according to Embodiment 3, for the user who wants the close connection, for example, it comes to be easily connected again with the user who is connected once through the virtual network, and thus, an effect of working effectively as a place for creating a friendship can be expected. In contrast, for the user who does not want the person connected through the virtual network to be connected in the real world, when it is adapted to be not connected again with the once-connected user, it is possible to cut and divide the friendship in the virtual network from the one in the real world.

### Embodiment 4

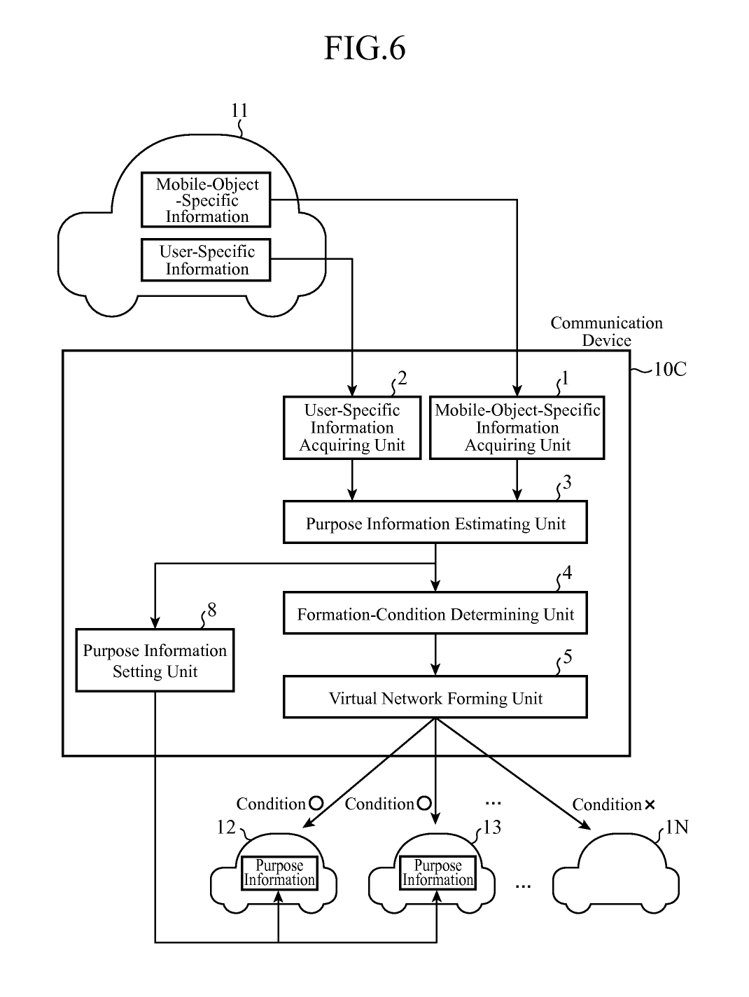

FIG. 6 is a block diagram illustrating a configuration of a communication system in Embodiment 4 of the present invention. The same constituent components as those described in Embodiments 1 to 3 will be denoted by the same reference numerals, and redundant descriptions thereof will be omitted. In Embodiment 4 described below, as compared with Embodiment 1, a communication device 10C includes a purpose information setting unit 8, and the purpose information used for determining a formation condition for a virtual network is shared by other mobile objects in the formed virtual network.

The purpose information setting unit 8 sets the purpose information estimated by a purpose information estimating unit 3 as the purpose information of the other mobile objects in the virtual network formed by a virtual network forming unit 5 and shares the set purpose information with all mobile objects in the virtual network.

Incidentally, in this case, although the original purpose information used for determining the formation condition for the virtual network is shared as it is, it may be devised that the purpose information of one or a plurality of mobile objects (for example, the mobile objects and the like included in the virtual network later) in the formed virtual network is shared with all mobile objects in the virtual network.

Moreover, the following may be configured: new purpose information is recommended based on the purpose information of the one or the plurality of mobile objects in the formed virtual network, and then set as the purpose information of all mobile objects in the virtual network, and the set purpose information is shared with all mobile objects in the virtual network.

Specifically, for example, in a case where the virtual network is formed based on a loose formation condition, and also the purpose information of the mobile object in the virtual network is different, it is configured that a destination that satisfies a relatively loose condition like destination locations and genres of all pieces of purpose information may be automatically recommended and shared. In this case, the automatic recommendation includes the following: when only rough purpose information of “Destination=Ski Resort,” for example, is provided, a specific recommended place of “Destination=Sanda Ski Resort” as a place close to the current places of the plurality of mobile objects that forms the virtual network is shared as the purpose information; the purpose information set as the destination by the majority of the mobile objects among the pieces of purpose information of all mobile objects is provided as the purpose information to be recommended by the virtual network; and when only the purpose information of any one of the mobile objects is definite among the pieces of purpose information that are obscure as a whole, the definite purpose information is provided as the purpose information to be recommended by the virtual network.

For example, it is assumed that there exist a user A that wants to go to Sanda Ski Resort and users B and C that want to go to any ski resorts. In this case, although the purpose information of the user A is “Destination=Sanda Ski Resort,” when the user A wants a loose formation condition, the user A is connected through the same virtual network as that of the users B and C of which the purpose information is “Genre=Ski Resort”. As a result, “Destination=Sanda Ski Resort” which is the purpose information of the user A is shared with the users B and C, whereby the purpose that is obscure for the users B and C becomes definite.

As described above, according to Embodiment 4, it becomes possible that the mobile objects connected through the virtual network head to the same destination. This is particularly effective in the virtual network that is formed according to the loose formation condition. Moreover, since the users head to the destination while communicating with each other, an effect as a place for making friends can be expected.

### Embodiment 5

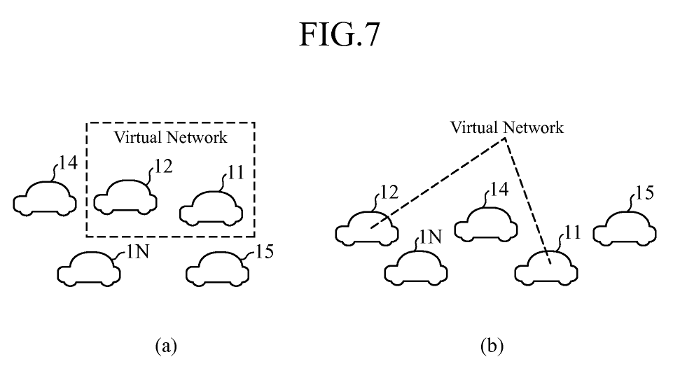

FIGS. 7(a) and 7(b) are diagrams each illustrating a positional relation between mobile objects in a virtual network of a communication system in Embodiment 5 of the present invention. The same constituent components as those described in Embodiments 1 to 4 will be denoted by the same reference numerals, and redundant descriptions thereof will be omitted. In Embodiment 5 described below, it is characterized that when automated travel control of mobile objects is enabled, all mobile objects in a virtual network are controlled so as to travel while maintaining a specific positional relation.

For example, when it is desirable to move together with users connected through the virtual network, as illustrated in FIG. 7(a), the mobile object 12 in the same virtual network as that of the mobile object 11 is controlled so as to move while maintaining a close distance to the mobile object 12. In contrast, for the users who do not think to want a person connected through the virtual network to be connected in the real world, as illustrated in FIG. 7(b), the mobile object 11 is controlled so as to move in a position always apart from the mobile object 12 in the same virtual network.

As described above, according to Embodiment 5, for example, in a case where the communication system is used as a place for making friends, by moving while maintaining the close distance, an effect such that a deeper sense of togetherness can be obtained to thus strengthen a friendship between the users can be expected. In contrast, for the users who do not think to want the person connected through the virtual network to be connected in the real world, such as female users who are unwilling to meet the user whose identity is unknown, by moving while maintaining a long distance, it is possible to cut and divide the friendship in the virtual network from the one in the real world; thus, this communication system can be used at ease.

### Embodiment 6

In Embodiments 1 to 5 described above, in the communication system of the present invention, there is described an example in which an external device (server) that can communicate with the plurality of mobile objects functions as the communication device 10 (10, 10A to 10C), which includes at least the purpose information estimating unit 3, the formation-condition determining unit 4, and the virtual network forming unit 5 to thus perform various controls; however, there may be a configuration in which the external server is not used, like a case in which the functions of these purpose information estimating unit 3, formation-condition determining unit 4, and virtual network forming unit 5 are incorporated in an in-vehicle information device inside the mobile object or a mobile information terminal such as a smartphone.

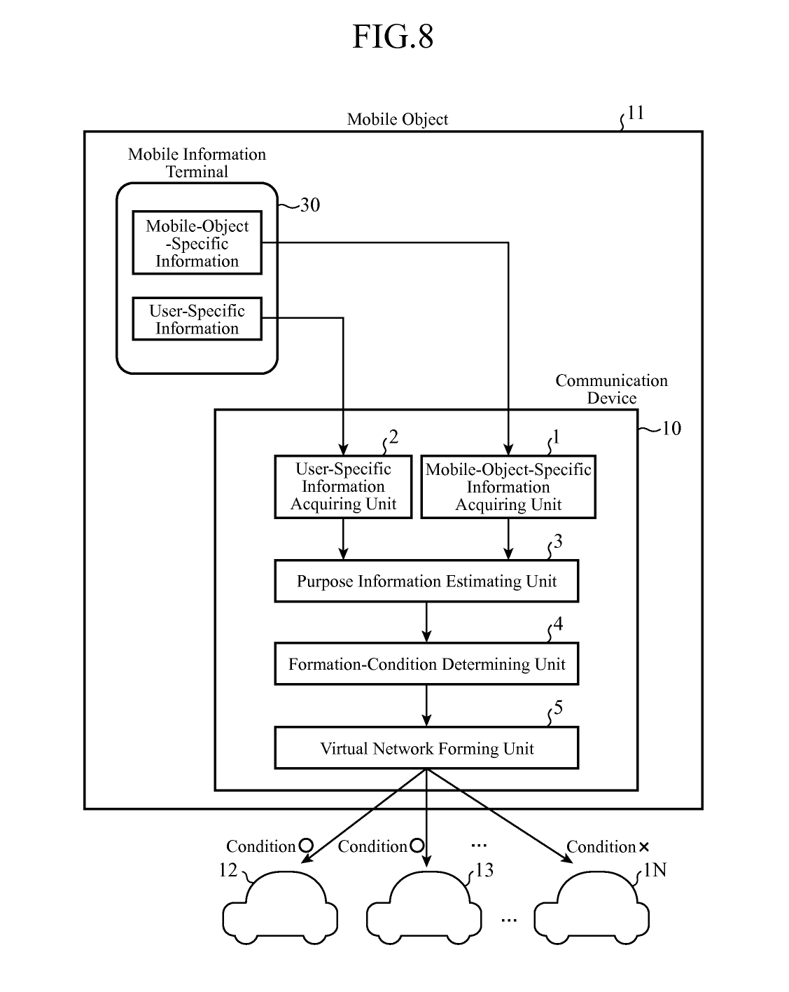

FIG. 8 is a block diagram illustrating a configuration of a communication system in Embodiment 6 of the present invention. The same constituent components as those described in Embodiments 1 to 5 will be denoted by the same reference numerals, and redundant descriptions thereof will be omitted. In the configuration illustrated in FIG. 8, it is assumed that a mobile information terminal 30 has mobile-object-specific information as well as user-specific information. Then, an in-vehicle information device mounted on a mobile object 11 has a function of a communication device 10 similar to that of Embodiment 1. Incidentally, it goes without saying that the device may include communication devices 10A to 10C similar to those of Embodiments 2 to 4.

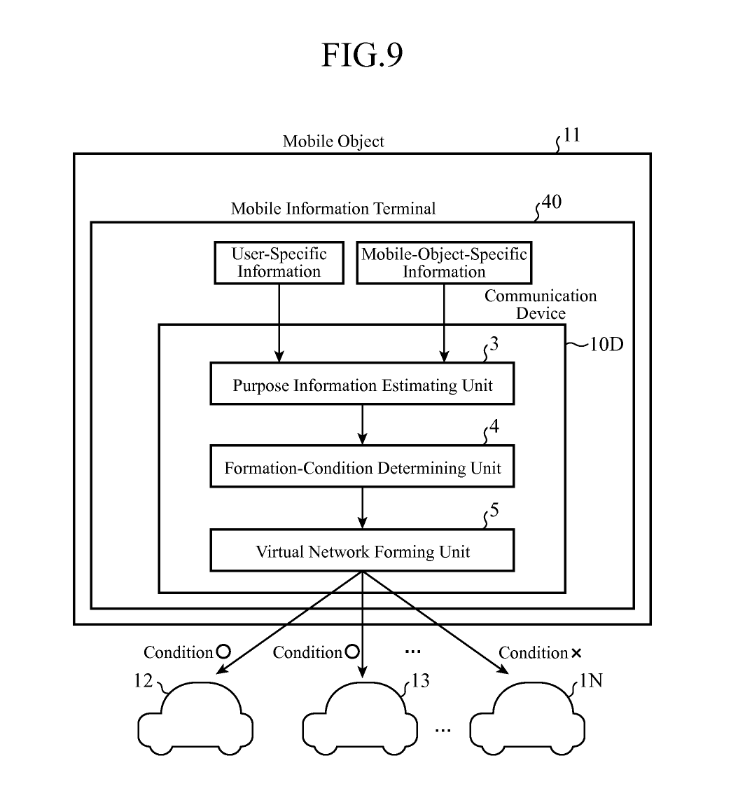

In addition, FIG. 9 is a block diagram illustrating another configuration of the communication system in Embodiment 6 of the invention. In this configuration, it is also assumed that a mobile information terminal 40 has the mobile-object-specific information as well as the user-specific information. Moreover, in the configuration illustrated in FIG. 9, the mobile information terminal 40 possessed by a user inside the mobile object 11 has the function of a communication device 10D that includes the purpose information estimating unit 3, formation-condition determining unit 4, and virtual network forming unit 5.

In this manner, when the in-vehicle information device and/or the mobile information terminal inside the mobile object is configured to have the function of the communication device that includes at least the purpose information estimating unit 3, formation-condition determining unit 4, and virtual network forming unit 5, it is possible to establish a local server inside the mobile object and to form the virtual network. Thus, even when there exists no external device of the moving object such as the server, it is possible to provide the same effects as those of Embodiments 1 to 5.

Embodiments of the invention of the present application can be freely combined with each other, and optional constituent components of the respective embodiments may be modified or omitted within the scope of the invention.

### INDUSTRIAL APPLICABILITY

In the present invention, it is not limited to the communication device for the automobile, but it is also applicable to entities in any forms, for example, for the mobile objects including vehicles other than motorcycles, and/or automobiles such as buses etc., persons, trains, ships, and so on.

### DESCRIPTION OF REFERENCE NUMERALS AND SIGNS

1: Mobile-object-specific information acquiring unit
2: User-specific information acquiring unit
3: Purpose information estimating unit
4, 4A: Formation-condition determining unit
5, 5B: Virtual network forming unit
6: Mobile-object-surrounding information acquiring unit
7: Virtual-network-formation history storage unit
8: Purpose information setting unit
10, 10A, 10B, 10C, 10D: Communication device
11 to 1N: Mobile object
20: Display device of mobile object
21: Indication of fellowship
30, 40: Mobile information terminal.

1. A communication device having a function of communicating with a plurality of mobile objects, the communication device comprising:
a purpose information estimator that estimates purpose information indicating a purpose of movement of a user who moves using the mobile object, based on mobile-object-specific information that includes at least one of a usage schedule and a usage history of the mobile object, and user-specific information that includes at least one of an activity schedule and an activity history of the user who moves using the mobile object;
a formation-condition determinator that determines a formation condition for a virtual network for the mobile objects of which the purpose information estimated by the purpose information estimator is the same or similar, based on the mobile-object-specific information and the user-specific information in the plurality of mobile objects; and
a virtual network former that forms a virtual network through which the mobile objects that satisfy the formation condition determined by the formation-condition determinator among the plurality of mobile objects can communicate with each other.

2. The communication device according to claim 1, further comprising:
a mobile-object-surrounding information acquirer that acquire surrounding information of the mobile object, wherein
the formation-condition determinator determines the formation condition for the virtual network for the mobile objects of which the purpose information is the same or similar, based on the surrounding information of the plurality of mobile objects in addition to the mobile-object-specific information and the user-specific information.

3. The communication device according to claim 1, further comprising:
a virtual-network-formation history storage that stores a formation history of the virtual network, wherein
the virtual network former forms the virtual network based on the formation history stored in the virtual-network-formation history storage.

4. The communication device according to claim 1, wherein
the formation-condition determinator determines and presents a plurality of formation conditions as the formation condition for the virtual network, and
the virtual network former forms the virtual network using a group of mobile objects made up of the plurality of mobile objects that satisfies a formation condition selected from among the plurality of formation conditions presented by the formation-condition determinator.

5. The communication device according to claim 1, further comprising:
a purpose information setter that sets the purpose information estimated by the purpose information estimator as the purpose information of other mobile objects in the virtual network formed by the virtual network former,
wherein
the purpose information setter shares the set purpose information with all mobile objects in the virtual network.

6. The communication device according to claim 1, further comprising:
a purpose information setter that recommends new purpose information based on the purpose information of one or a plurality of mobile objects in the virtual network formed by the virtual network former, and sets the new purpose information as the purpose information of all mobile objects in the virtual network, wherein
the purpose information setter shares the set purpose information with all mobile objects in the virtual network.

7. The communication device according to claim 1, wherein
a location of a mobile object in the virtual network is displayed on a display device provided in the mobile object.

8. The communication device according to claim 1, wherein
the communication device is a device that automated travel control of the mobile object is enabled, and
the communication device controls all mobile objects in the virtual network so as to travel while maintaining a specific positional relation.

9. The communication device according to claim 1, wherein
the virtual network former excludes a mobile object not satisfying the formation condition from the virtual network.

10. A communication method in a communication device that has a function of communicating with a plurality of mobile objects, the method comprising:
by a purpose information estimator, estimating purpose information indicating a purpose of movement of a user who moves using the mobile object, based on mobile-object-specific information that includes at least one of a usage schedule and a usage history of the mobile object, and user-specific information that includes at least one of an activity schedule and an activity history of the user who moves using the mobile object;
by a formation-condition determinator, determining a formation condition for a virtual network for the mobile objects of which the purpose information estimated by the purpose information estimator is the same or similar, based on the mobile-object-specific information and the user-specific information in the plurality of mobile objects; and
by a virtual network former, forming a virtual network through which the mobile objects that satisfy the formation condition determined by the formation-condition determinator among the plurality of mobile objects can communicate with each other.
